(19) United States
(12) Patent Application Publication
(10) Pub. No.: US 2024/0388626 A1
(43) Pub. Date: Nov. 21, 2024

(54) METHOD AND SENSOR SYSTEM FOR MANAGING SENSORS IN ENVIRONMENT

(71) Applicant: Digitectura Technologies Pvt. Ltd, Bengaluru (IN)

(72) Inventor: Murugavelu Thangavelu, Bengaluru (IN)

(73) Assignee: Digitectura Technologies Pvt. Ltd, Bengaluru (IN)

(21) Appl. No.: 18/318,653

(22) Filed: May 16, 2023

(51) Int. Cl. H04L 67/12; G01B 21/16; G01S 5/02

(52) U.S. Cl. CPC H04L 67/12; G01B 21/16; G01S 5/0295

(57) ABSTRACT

Embodiments herein provide a sensor system (200) for managing sensors (300a-N) in an environment. The sensor system (200) includes plurality of sensors (300a-N) communicating with each other in a vicinity and configured to determine sensors (300a-N) parameter associated with another sensors (300b-N), wherein sensors (300a-N) includes a Neighboring sensor parameter database configured to store the sensors (300a-N) parameter in an order based on a proximity of the another sensors (300b-N). The sensor management controller connected to the plurality of sensors (300a-N), and configured to determine an aggregated sensor parameters based on the parameter received from the plurality of sensors (300a-N). A cloud management server (400) connected to the sensor management controller and configured to receive the aggregated sensor parameters from the sensor management controller and environmental parameter, and estimate a position of the plurality of sensors (300a-N) based on the aggregated sensor parameters and the environmental parameter.

### FIELD

The embodiment herein relates to a sensor management and more particularly to a method and a sensor system for managing sensors in an environment.

### BACKGROUND

In general, installation and commissioning of building management system is a cumbersome activity as it involves a large workforce and manual intervention. The large workforce requires to be stationed in an installed location, the workforce is required to identify location of the installation on a floor/building manually and mark the same in the building management system. This requires a person to move around to different locations, between floors to identify a single device. In a large installation, it is time-consuming and labor-intensive.

The current building management system installation is done with manual work, where the manual work involves to identify and collect the information of the position of each sensors, and also collect the information of the light associated with each of the respective sensors and then use the collected information for commissioning and configurations of the building management system. The current building management system commissioning and configuration process is not an efficient methodology due to the error which is occurring in manual work.

Thus, it is desired to address the above-mentioned disadvantages and other shortcomings and provide a useful alternative.

### SUMMARY

Accordingly, the embodiments herein provide a sensor system for managing sensors in an environment. The sensor system includes a plurality of sensors communicating with each other in a vicinity. The sensor of the plurality of sensors configured to determine sensor parameter associated with another sensor of the plurality of sensors. The sensor includes a Neighboring sensor parameter database configured to store the sensor parameter associated with another sensor. The sensor parameter associated with another sensor is stored in an order based on a proximity of another sensor. A sensor management controller connected to the sensor and another sensor, and configured to determine at least one aggregated sensor parameter based on the sensor parameter received from the plurality of sensors. A cloud management server connected to the sensor management controller and configured to receive the at least one aggregated sensor parameter from the sensor management controller and environmental parameter, and estimate a position of the sensor and another sensor in the environment based on the at least one aggregated sensor parameter and the environmental parameter.

In an embodiment, the sensor management controller is configured to determine the at least one aggregated sensor parameter based on the received sensor parameter. The sensor management controller receives the sensor parameter from the sensor and also receives another sensor parameter from another sensor and performs an aggregation technique pre-configured at the sensor management controller on the received sensor parameter and another sensor parameter, and determines the at least one aggregated sensor parameter based on the aggregation technique performed on the received sensor parameter and another sensor parameter.

In an embodiment, the sensor management controller is further configured to send the at least one aggregated sensor parameter to the cloud management server through a pre-established communication link.

In an embodiment, the sensor is configured to determine the sensor parameter associated with another sensor based on determining a signal strength associated with another sensor in the vicinity of the sensor to identify the position of the another sensor corresponding to the sensor, and determine the sensor parameter associated with another sensor based on the signal strength associated with another sensor and the position of another sensor corresponding to the sensor.

In an embodiment, the position of the sensor and another sensor is estimated in the environment based on the at least one aggregated sensor parameter and the environmental parameter that includes determine an identity of the sensor management controller sending the at least one aggregated sensor parameter to determine the position of the sensor management controller in the environment based on the environmental parameter, and filter the sensor and another sensor based on the identity of the sensor management controller. Also, performing a sensor identification technique on the filtered sensor and another sensor to estimate the position of the sensor and another sensor in the environment.

In an embodiment, the sensor identification technique includes mapping of the filtered sensor and another sensor based on the at least one environmental parameter.

In an embodiment, the environmental parameter is a layout of the environment, a layout density of the plurality of sensors in the environment, a height information associated with the environment, unique ID associated with each of the at least one sensor and the at least one another sensor, and position information of the at least one sensor management controller.

In an embodiment, the cloud management server is further configured to determine control command to be executed on the sensor and another sensor based on the estimated position; and send the control command to the sensor and another sensor through the at least one sensor management controller.

In an embodiment, the cloud management server is further configured to send the estimated position of the sensor and another sensor and the environmental parameter associated with the environment, through the sensor management controller to a display device, the display device displays the estimated position with respect to the environmental parameter.

Accordingly, the embodiments herein provide a method for managing sensors in an environment. The method includes determining the sensor parameter associated with the another sensor based on communicating with another sensor in a vicinity; storing the sensor parameter associated with the another sensor in an order based on the proximity of the at least one another sensor; transferring the sensor parameter to sensor management controller; determine at least one aggregated sensor parameter based on the at least one sensor parameter received from the plurality of sensors, the sensor management controller connected to the sensor; transferring the at least one aggregated sensor parameter and environmental parameter to a cloud management server connected to the sensor management controller; and estimating a position of the sensor and the another sensor in the environment based on the at least one aggregated sensor parameter and the environmental parameter.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

The embodiment is illustrated in the accompanying drawings, throughout which like reference letters indicate corresponding parts in the various figures. The embodiments herein will be better understood from the following description with reference to the drawings, in which:

FIG. 1 is an example illustrating a sensor management system, according to the prior art;

FIG. 2 illustrates a sensor system for managing sensors in an environment, according to an embodiment as disclosed herein;

FIG. 3A is a block diagram of a sensor of the sensor system, according to an embodiment as disclosed herein;

FIG. 3B is a block diagram of a sensor management controller of the sensor system, according to an embodiment as disclosed herein;

FIG. 4 is a block diagram of a cloud management server of the sensor system, according to an embodiment as disclosed herein;

FIG. 5 is a flow chart illustrating for a method for managing the sensors in the environment, according to an embodiment as disclosed herein;

FIG. 6 illustrates example connections between plurality of sensors in the sensor system, according to an embodiment as disclosed herein;

FIG. 7 illustrates an example layout comprising the sensor system for identifying the plurality of sensors in the environment, according to an embodiment as disclosed herein;

FIG. 8 illustrates an example environment comprising the plurality of sensors and sensor management controllers of the sensor system in an graphical representation, according to an embodiment as disclosed herein;

FIG. 9 illustrates another example environment comprising the plurality of sensors and sensor management controllers of the sensor system in an graphical representation, according to an embodiment as disclosed herein; and

FIG. 10 is a flow chart illustrating step-by-step process for estimating a location of the plurality of sensors in the environment by the sensor system, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a sensor system for managing sensors in an environment. The sensor system includes a plurality of sensors communicating with each other in a vicinity. The sensor of the plurality of sensors configured to determine sensor parameter associated with another sensor of the plurality of sensors. The sensor includes a Neighboring sensor parameter database configured to store the sensor parameter associated with another sensor. The sensor parameter associated with another sensor is stored in an order based on a proximity of another sensor. A sensor management controller connected to the sensor and another sensor, and configured to determine an at least one aggregated sensor parameter based on the sensor parameter received from the plurality of sensors. A cloud management server connected to the sensor management controller and configured to receive the at least one aggregated sensor parameter from the sensor management controller and environmental parameter, and estimate a position of the sensor and another sensor in the environment based on the at least one aggregated sensor parameter and the environmental parameter.

Accordingly, the embodiments herein provide a method for managing sensors in an environment. The method includes determining sensor parameter associated with the another sensor based on communicating with another sensor in a vicinity; storing the sensor parameter associated with the another sensor in an order based on a proximity of the at least one another sensor; transferring the sensor parameter to sensor management controller; determining an at least one aggregated sensor parameter based on the at least one sensor parameter received from the plurality of sensors, the sensor management controller connected to the sensor; transferring the at least one aggregated sensor parameter and environmental parameter to a cloud management server connected to the sensor management controller; and estimating a position of the sensor and the another sensor in the environment based on the at least one aggregated sensor parameter and the environmental parameter.

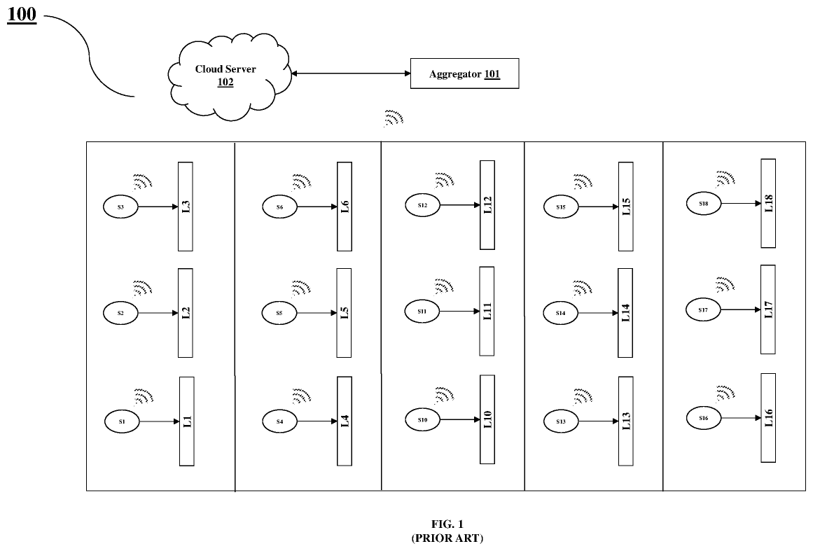

FIG. 1 is an example illustrating a sensor management system (100), according to the prior art.

In the conventional method, referring to the FIG. 1 illustrates the sensor management system, for example an office space has a square meter of 1000 sqmt. The plurality of sensors (S1-N) (wireless occupancy and light control sensors) connected with the light ballasts (L1-LN) which is placed across the office environment and also placing at least one aggregator (101) to control the sensors across the office environment, where the aggregator (101) is connected to the cloud server (102) which is configured to control the plurality of sensors (S1-N) with respect to the data collected from the aggregator (101). In this methods, there is a need for more manual work to find the location and position of the sensor devices around that office environment which have to be switched ON, so the manpower increases exponentially with the increase of area and count of sensors. And also, the configuration is different for each sensor due to the location and comfort of the user.

Unlike the conventional method, the sensor management system (200) includes sensor (300a) configured to receive the signal strength of the plurality of nearby sensors (300a-N) and sending the nearby sensor information to the cloud management server (400) through sensor management controller (310a) and the cloud management server (400) configured to filter the sensors (300a-N) which are nearer to the sensor management controller (310a) to identify the location of the sensors (300a-N) without the requirement of manpower.

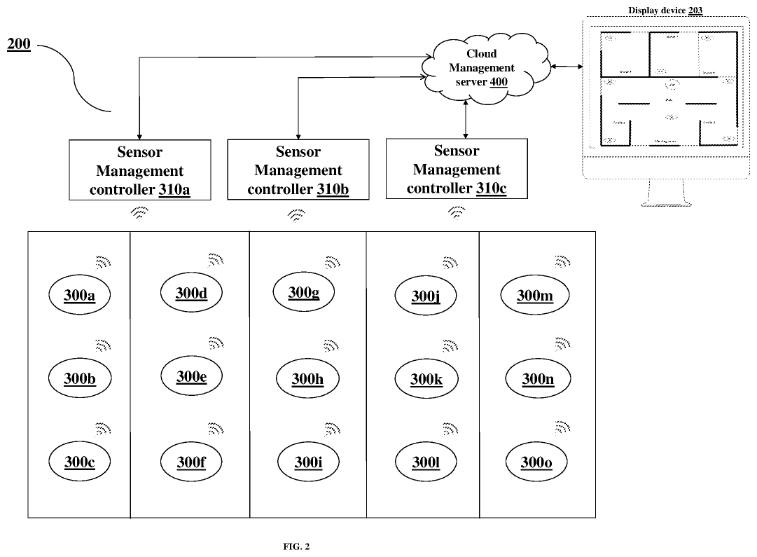

Referring now to the drawings and more particularly to FIGS. 2 through 10, where similar reference characters denote corresponding features consistently throughout the figures, there are shown preferred embodiments.

FIG. 2 illustrates the sensor system (200), according to an embodiment as disclosed herein.

Referring to the FIG. 2, the sensor system (200) includes sensors (300a-N) which are installed in an indoor environment such as for example a corporate office space, a community hall, an education institution, etc. The sensor system (200) includes a plurality of sensors (300a-N) that communicate with another sensors (300b-N) in the vicinity. The plurality of sensors (300a-N) is configured to determine the sensor parameters associated with another sensors (300b-N), where the sensor parameters represents the signal strength associated with another sensors (300b-N) in the vicinity of the plurality of sensors (300a-N). The signal strength associated with another sensors (300b-N) are determined to identify the position of another sensors (300b-N) in the vicinity of the plurality of sensors (300a-N).

The sensors (300a-N) are configured to collect the location information of nearby sensors (300a-N) based on detecting the signal strength from the nearby sensors (300a-N), and the sensors (300a-N) transmit the location information of the nearby sensors (300a-N) to the respective sensor management controller (310a) which are in proximity to the specific sensors (300a-N). The sensor management controller (310a) is configured to transmit the location information to the cloud management server (400). The cloud management server (400) determines the accurate location of the sensors (300a-N) by filtering sensors which are in proximity to the sensor management controller (310a) based on location information of sensors (300a-N) received from the sensor management controller (310a) and environmental parameters.

The plurality of sensor management controllers (310a-N) are installed in the environment and the plurality of sensor management controllers (310a-N) are connected to the plurality of sensors (300a-N). The plurality of sensor management controllers (310a-N) are configured to determine aggregated sensor parameters based on the sensor parameters received from the plurality of sensors (300a-N). The aggregated sensor parameters is determined based on performing an aggregation technique on the received sensor parameters from the plurality of sensors (300a-N). The aggregation technique is preconfigured in each of the plurality of sensor management controllers (310a-N).

The cloud management server (400) connected to the plurality of sensor management controllers (310a-N) via communication link. The cloud management server (400) configured to receive the aggregated sensor parameters from the plurality of sensor management controllers (310a-N) and the environmental parameters. The cloud management server (400) estimates a position of the plurality of sensors (300a-N) in the environment based on the aggregated sensor parameters and the environmental parameters. The environmental parameter can be for example a layout of the environment, a layout density of the plurality of sensors in the environment, a height information associated with the environment, unique ID associated with each of the at least one sensor (300a) and the at least one another sensor (300b), and position information of the at least one sensor management controller (310a).

The cloud management server (400) is configured to determine an identity of the plurality of sensor management controllers (310a-N) sending the aggregated sensor parameters and determines the position of the plurality of sensor management controllers (310a-N) in the environment based on the environmental parameter. The cloud management server (400) is configured to filter the plurality of sensors (300a-N) based on the identity of the plurality of sensor management controllers (310a-N). Also, perform a sensor identification technique on the filtered plurality of sensors (300a-N), and estimate the position of the plurality of sensors (300a-N) in the environment. The sensor identification technique includes mapping of the filtered plurality of sensors (300a-N) based on the environmental parameter.

In an embodiment, the cloud management server (400) is further configured to determine control command to be executed on the plurality of sensors (300a-N) based on the estimated position, and send the control commands to the plurality of sensors (300a-N) through the plurality of sensor management controllers (310a-N). For example consider, the plurality of sensors (300a-N) are light sensors. Then the control commands are for example, a command to control intensity of the light, command to control a color of the light, etc. In another example consider, the plurality of sensors (300a-N) are temperature sensors. Then the control command is for example, the command to control temperature of the environment by controlling the air conditioner. The control commands are transferred to the plurality of sensors (300a-N) through the plurality of sensor management controllers (310a-N) to control the plurality of sensors (300a-N) according to the specification of the plurality of sensors (300a-N).

In another embodiments, the cloud management server (400) further configured to send the estimated position of the plurality of sensors (300a-N) and the environmental parameter associated with the environment, to a display device (203) for displaying the estimated position with respect to the environmental parameter.

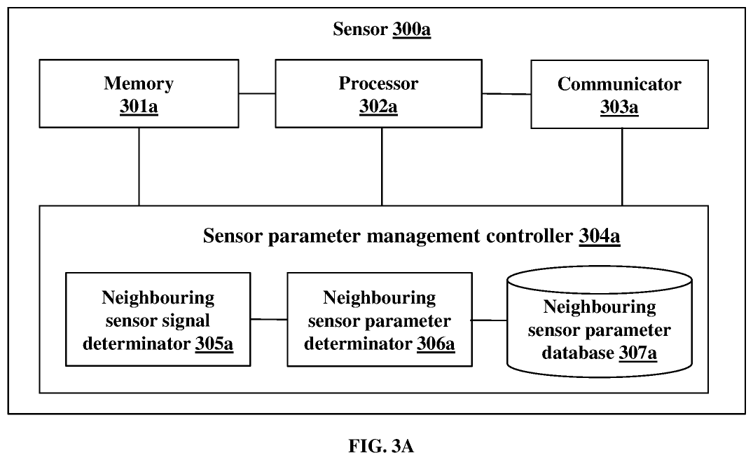

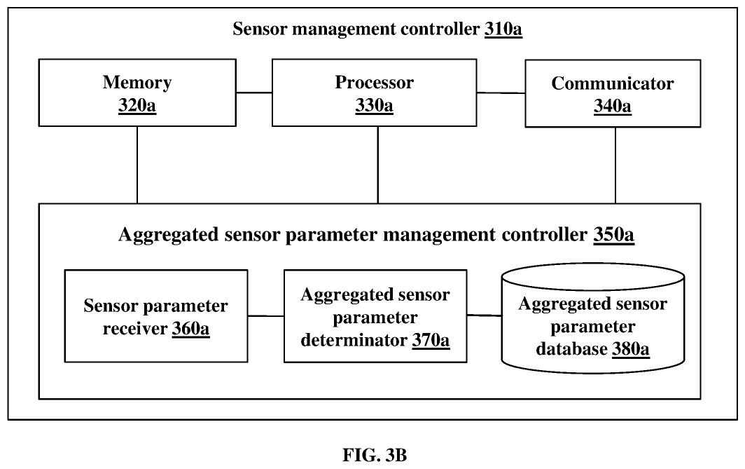

FIG. 3A is a block diagram of a sensor of the sensor system (200), according to an embodiment as disclosed herein;

Referring to the FIG. 3A illustrates the sensor (300a). The sensor (300a) can be a plurality of sensors (300a-N) communicating with each other in the sensor system. In FIG. 3A illustrates only a single sensor (300a) is considered for illustration purpose.

In an embodiment, the sensor (300a) includes a memory (301a), a processor (302a), a communicator (303a), and a sensor parameter management controller (304a).

The memory (301a) is configured to store instructions to be executed by the processor (302a). The memory (301a) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (301a) may, in some examples, be considered a non-transitory storage medium. The term “non-transitory” may indicate that the storage medium is not embodied in a carrier wave or a propagated signal. However, the term “non-transitory” should not be interpreted that the memory (301a) is non-movable. In some examples, the memory (301a) is configured to store larger amounts of information. In certain examples, a non-transitory storage medium may store data that can, over time, change (e.g., in Random Access Memory (RAM) or cache).

The processor (302a) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (140) may include multiple cores and is configured to execute the instructions stored in the memory (301a).

The sensor parameter management controller (304a) includes a neighbouring sensor signal determinator (305a), a neighbouring sensor parameter determinator (306a), and a neighbouring sensor parameter database (307a).

The neighbouring sensor signal determinator (305a) of the sensor (300a) is configured to determine the signal strength associated with another sensors (300b-N) which are distributed in the vicinity and determine the position of the another sensors (300b-N) with respect to the sensor (300a).

The neighbouring sensor parameter determinator (306a) of the sensor (300a) is configured to determine the sensor (300a) parameter associated with another sensors (300b-N) based on the signal strength associated with another sensors (300b-N). The sensor (300a) parameter represents the unique ID of another sensors (300b-N), distance of another sensors (300b-N), where the distance is determined based on the signal strength range received from the another sensors (300b-N). The neighbouring sensor parameter determinator (306a) configured to prioritize another sensors (300b-N) based on the sensor (300a) parameter associated with another sensors (300b-N). The prioritized sensor parameters is stored in the Neighbouring sensor parameter database (307a) of the sensor (300a).

For example, the sensors (300b, 300c, and 300d) are placed in proximity to the sensor (300a). The wireless sensor (300a) is configured to receive the signal strength from each of the sensors (300b, 300c and 300d) in the proximity. The sensor (300a) segregates the proximity sensors (300b, 300c and 300d) based on the signal strength received from each of the proximity sensors (300b, 300c and 300d). For instance, if the sensor (300a) receives the signal from the sensor (300b) with high signal strength, then the sensor (300b) is given scores such as score 1, score 2 and the like. Further, if the sensor (300a) receives the signal from the sensor (300c) with medium signal strength, then the sensor (300c) is given scores such as score 3, score 4 and the like. Also, if the sensor (300a) receives the signal from the sensor (300d) with low signal strength, then the sensor (300d) is given scores such as score 5, score 6 and the like.

Further, the scores are stored in a Neighbouring sensor parameter database (307a) of the sensor (300a). The sensor (300a) categorizes the scores based on the signal strength (such as high, medium, and low) and stores in the Neighbouring sensor parameter database (307a). The scores are categorized and stored in the Neighbouring sensor parameter database (307a) in a table format. The sensors (300b, 300c and 300d) can include unique IDs (S2, S3, and S4). The unique IDs can be serial numbers given to the sensors to uniquely identify the particular sensor.

TABLE 1

| Unique ID | Sensor | Distance | Score |
|---|---|---|---|
| S2 | sensor (300b) | Less than 1 meter | 1 |
| S3 | sensor (300c) | More than 1 meter | 2 |
| S4 | sensor (300d) | More than 2 meter | 4 |

Table. 1 describes the scoring pattern of the wireless sensors based on the signal strength. The distance can be for example less than 1 meter, more than 1 meter, more than 2 meter and so on. The scoring is based on the distance of the sensors (300a-N) in the proximity. If the distance is less, then the signal strength will be more and if as the distance is increased the signal strength is decreased. The sensors shown in the table is not limited to only three (S2, S3 and S4) sensors, the sensors (300a-N) can be more than three. Also, the distance shown in the table is not limited to only 1 or 2 meters, the distance can be more or less.

The sensor (300a) includes the Neighbouring sensor parameter database (307a) used to store the location information of each of the nearby sensor of the another sensors (300b-N), where the Neighbouring sensor parameter database (307a) maintains the table to store the location information in a ranking manner, where the ranking is defined based on signal strength received from the each of the nearby sensor of the another sensors (300b-N). The sensor (300a) maintains a data table which contains the information of other sensors around it. This information is sent to cloud management server (400) through the sensor management controllers (310a-N). The location algorithm takes the data from every sensor as input and computes the accurate position of the plurality of sensors (300a-N) with reference to 2 or more known sensor locations.

The sensor parameter management controller (304a) may be implemented through an AI model. A function associated with the AI model may be performed through memory (301a) and the processor (302a). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment, the communicator (303a) includes an electronic circuit specific to a standard that enables wired or wireless communication. The communicator (303a) is configured to communicate internally between internal hardware components of the wireless sensor (300a) and with external devices via one or more networks.

FIG. 3B is a block diagram of a sensor management controller (310a) of the sensor system (200), according to an embodiment as disclosed herein.

Referring to the FIG. 3B illustrates the architecture of sensor management controller (310a) in the sensor system (200). The sensor management controller (310a) includes a memory (320a), a processor (330a), a communicator (340a), and an aggregated sensor parameters management controller (350a).

The memory (320a) is configured to store instructions to be executed by the processor (330a). The memory (320a) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (320a) may, in some examples, be considered a non-transitory storage medium. The term “non-transitory” may indicate that the storage medium is not embodied in a carrier wave or a propagated signal. However, the term “non-transitory” should not be interpreted that the memory (320a) is non-movable. In some examples, the memory (320a) is configured to store larger amounts of information. In certain examples, a non-transitory storage medium may store data that can, over time, change (e.g., in Random Access Memory (RAM) or cache).

The processor (330a) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (330a) may include multiple cores and is configured to execute the instructions stored in the memory (320a).

In an embodiment, the communicator (340a) includes an electronic circuit specific to a standard that enables wired or wireless communication. The communicator (340a) is configured to communicate internally between internal hardware components of the sensor management controller (310a) and with external devices via one or more networks.

The Aggregated sensor parameters management controller (350a) includes a sensor parameters receiver (360a), an aggregated sensor parameters determinator (370a), and an aggregator sensor parameter database (380a).

The sensor parameter receiver (360a) configured to receive the sensor parameters from the plurality of sensors (300a-N) and the aggregated sensor parameter determinator (370a) configured to perform the aggregation technique on the received sensor parameters from the plurality of sensors (300a-N), where the aggregation technique is pre-configured in the plurality of sensor management controllers (310a-N). The aggregation technique configured to determine which sensors (300a-N) are closer to which sensor management controllers (310a-N).

For example, referring to FIG. 2, if the particular sensors (300a, 300b, and 300d) of the plurality of sensors (300a-N) transferring the sensor parameters to the sensor management controller (310a), then the sensor management controller (310a) determines the aggregated sensor parameters by performing the aggregation technique on the sensor parameters which is received from the particular sensors (300a, 300b, and 300d) of the plurality of sensors (300a-N) and once the aggregation technique is performed then the sensor management controller (310a) determines the sensors (300a, 300b, and 300d) which are nearer to it. Similarly, if the particular sensors (300m, 300n, and 300j) of the plurality of sensors (300a-N) transferring the sensor parameters to the sensor management controller (310c), then the sensor management controller (310c) determines aggregated sensor parameters by performing the aggregation technique on the sensor parameters which is received from the particular sensors (300m, 300n, and 300j) of the plurality of sensors (300a-N) and once the aggregation technique is performed then the sensor management controller (310c) determines the sensors (300m, 300n, and 300j) which are nearer to it. Based on the examples, the sensor management controller is not limited to one sensor management controller, the sensor management controller can be more than one sensor management controllers (310a-N). Similarly, the sensors are not limited to three, the sensor can be more than three sensors (310a-N).

Once the plurality of sensor management controllers (310a-N) determines the aggregated sensor parameters based on the sensor parameters received from the plurality of sensors (300a-N). The aggregated sensor parameters is stored in the aggregated sensor parameter database (380a) and transferring the stored aggregated sensor parameters to the cloud management server (400) through a pre-established communication link, where the communication link can be wired or wireless.

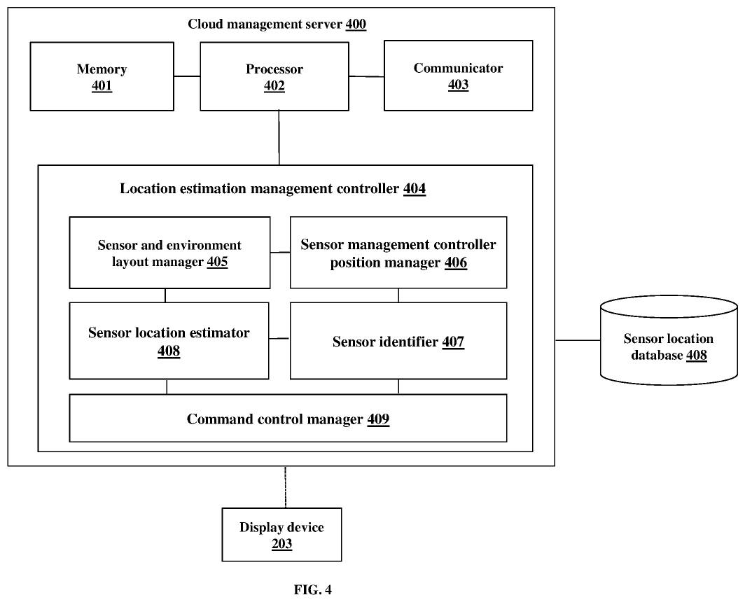

FIG. 4 is a block diagram of the cloud management server (400) of the sensor system (200), according to an embodiment as disclosed herein.

The memory (401) is configured to store instructions to be executed by the processor (402). The memory (401) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (401) may, in some examples, be considered a non-transitory storage medium. The term “non-transitory” may indicate that the storage medium is not embodied in a carrier wave or a propagated signal. However, the term “non-transitory” should not be interpreted that the memory (401) is non-movable. In some examples, the memory (401) is configured to store larger amounts of information. In certain examples, a non-transitory storage medium may store data that can, over time, change (e.g., in Random Access Memory (RAM) or cache).

The processor (402) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (402) may include multiple cores and is configured to execute the instructions stored in the memory (401).

The location estimation management controller (404) includes a sensor and environment layout manager (405), a sensor management controller position manager (406), a sensor location estimator (408), a sensor identifier (407), and a command control manager (409). Also, the location estimation management controller (404) is preconfigured with environmental parameter. The environmental parameter is a layout of the environment, a layout density of the plurality of sensors in the environment, a height information associated with the environment, unique ID associated with each of the plurality of sensors (300a-N), and position information of the at least one sensor management controller (310a). The sensor and environment layout manager (405) of the location estimation management controller (404) is preconfigured with the layout of the environment and a height information associated with the environment, the sensor location estimator (408) of the location estimation management controller (404) is preconfigured with a layout density of the plurality of sensors in the environment, the sensor management controller position manager (406) of the location estimation management controller (404) is preconfigured with position of the plurality of sensor management controllers (310a-N) with respect to the layout of the environment, and the sensor identifier (407) of the location estimation management controller (404) is preconfigured with the information of the sensors (300a-N), where the information of the sensors (300a-N) are represents the unique ID associated with the plurality of sensors (300a-N).

The sensor management controller position manager (406) of the location estimation management controller (404) configured to determine an identity of the plurality of sensor management controllers (310a-N) and determine the position of the plurality of sensor management controllers (310a-N) in the environment based on the preconfigured position information of the plurality of sensor management controllers (310a-N) and receiving the layout information of the environment from the sensor and environment layout manager (405).

The sensor identifier (407) of the location estimation management controller (404) performs the sensor identification technique by filter the plurality of sensors (300a-N) with respect to the position of the plurality of sensor management controllers (310a-N), layout of the environment, and the height information associated with the environment based on the preconfigured unique ID associated with each of the plurality of sensors (300a-N).

The sensor location estimator (408) of the location estimation management controller (404) configured to mapping of the filtered plurality of sensors (300a-N) based on layout of the environment, a layout density of the plurality of sensors in the environment, a height information associated with the environment, unique ID associated with each of the plurality of sensors (300a-N), and positon information of the at least one sensor management controller (310a).

The command control manager (409) of the location estimation management controller (404) configured to determine control commands to be executed on the plurality of sensors (300a-N) based on the estimated position, and sending the control commands to the plurality of sensors (300a-N) through the plurality of sensor management controllers (310a-N). For example consider, the plurality of sensors (300a-N) are light sensors. Then the control commands are for example, a command to control intensity of the light, command to control a color of the light, etc. In another example consider, the plurality of sensors (300a-N) are temperature sensors. Then the control command is for example, the command to control temperature of the environment by controlling the air conditioner. The control commands are transferred to the plurality of sensors (300a-N) through the plurality of sensor management controllers (310a-N) to control the plurality of sensors (300a-N) according to the specification of the plurality of sensors (300a-N).

The cloud management server (400) transferring the estimated position of the plurality of sensors (300a-N) along with the environmental parameter to a sensor location database (408). The sensor location database (408) can be placed inside the cloud management server (400) or outside of the cloud management server (400).

The cloud management server (400) sending the estimated position of the plurality of sensors (300a-N) along with the environmental parameter to a display device (204), where the display device (204) displays the estimated position with respect to the environmental parameter.

The location estimation management controller (404) may be implemented through an AI model. A function associated with the AI model may be performed through memory (401) and the processor (402). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment, the communicator (403) includes an electronic circuit specific to a standard that enables wired or wireless communication. The communicator (403) is configured to communicate internally between internal hardware components of the cloud management server (400) and with external devices via one or more networks.

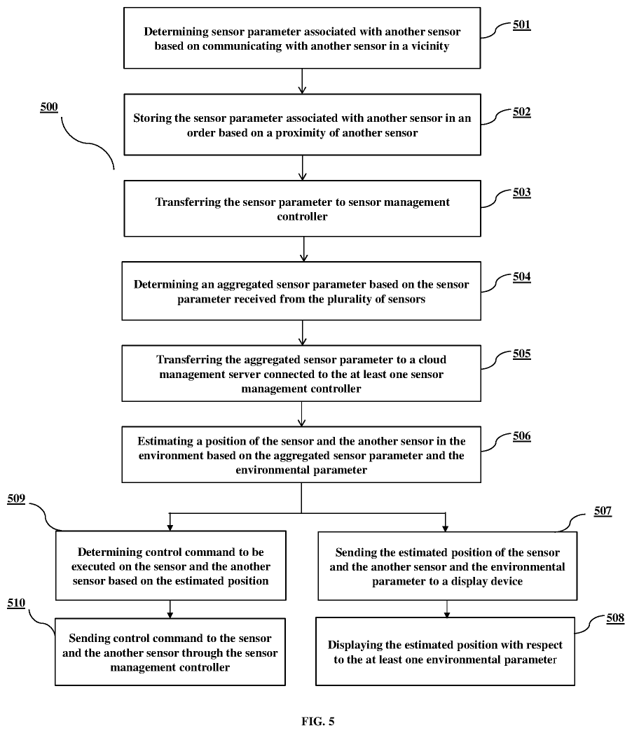

FIG. 5 is a flow chart illustrating for a method for managing the sensors (300a-N) in the environment, according to an embodiment as disclosed herein.

Referring to the FIG. 5, at step (501), the method includes the sensor (300a) determining sensor parameters associated with another sensor (300b) based on communicating with another sensors (300b-N) in a vicinity.

At step 502, the method includes the sensor (300a) storing the sensor parameters associated with another sensor (300b) in an order based on a proximity of another sensor (300b).)

At step 503, the method includes the sensor (300a) transferring the sensor parameters to sensor management controller (310a).

At step 504, the method includes the sensor management controller (310a) determining an aggregated sensor parameters based on the sensor parameters received from the plurality of sensors (300a-N).

At step 505, the method includes the sensor management controller (310a) transferring the aggregated sensor parameters to a cloud management server connected to the sensor management controller (310a).

At step 506, the method includes the cloud management server (400) estimating a position of the sensor (300a) and another sensor (300b) in the environment based on the aggregated sensor parameters and the environmental parameter.

At step 507, the method includes the cloud management server (400) sending the estimated position of the sensor (300a) and another sensor (300b) and the environmental parameter to a display device (203).

At step 508, the method includes displaying the estimated position with respect to the environmental parameter.

At step 509, the method further includes the cloud management server (400) determining control command to be executed on the sensor (300a) and another sensor (300b) based on the estimated position.

At step 510, the method further includes the cloud management server (400) sending control command to the sensor and another sensor through the sensor management controller.

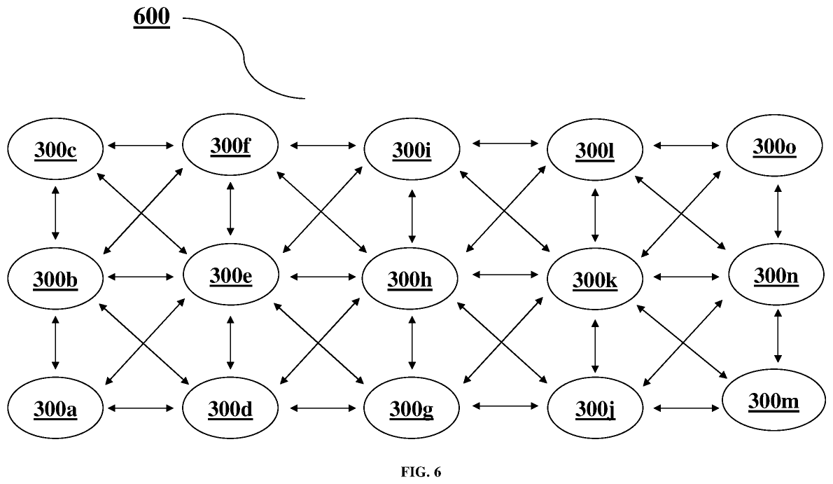

FIG. 6 illustrates example connections between plurality of sensors (300a-N) in the sensor system (200), according to an embodiment as disclosed herein.

Referring to FIG. 6 illustrates the plurality of sensors (300a-N) connected with each other via wireless medium in the sensor network (600). The wireless medium can be but not limited to a Bluetooth, Wi-Fi, wireless local area networks (WLANs), Infrared Communication, and a Microwave Communication. The wireless sensors (300a-N) can be but not limited to temperature sensor, light sensor, occupancy sensor and so on. The 300a-N can be a serial number of wireless sensors.

The sensors (300a-N) are connected such that all the sensors are in communication with each other for determining the location of the required sensor. For example considering the sensor (300c) receives signals from the sensors (300b, 300f, and 300e). Further, the sensor (300g) receives the signals from (300d, 300e, 300k, and 300j). The sensor (300c) transmits the location information of the sensors (300b, 300f, and 300e) to the respective sensor management controller (310a) and the sensor (300g) transmits the location information of the sensors (300d, 300e, 300k, and 300j) to the respective sensor management controller (310b).

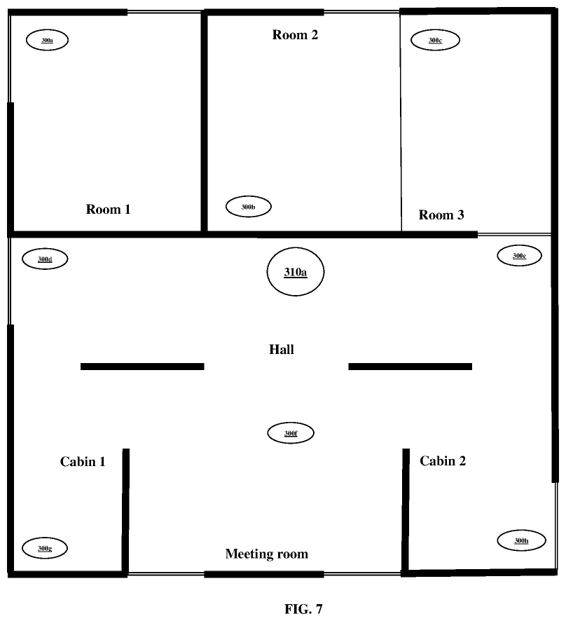

FIG. 7 illustrates an example layout comprising the sensor system for identifying the plurality of sensors in the environment, according to an embodiment as disclosed herein.

Referring to FIG. 7 illustrates an example indoor environment includes rooms, hall, meeting room, and cabin. The sensors (300a-N) placed across the indoor environment such as sensor (300a) placed in room 1, the sensor (300b) placed in room 2, and the sensor (300c) placed in room 3. Further, the sensors (300d and 300e) placed in hall. The sensors (300g and 300h) placed in cabin 1 and cabin 2. Also, the sensor (300f) placed in meeting room. The sensor management controller (310a) deployed in hall and controls all the sensors (300a-N) which are placed in the indoor environment.

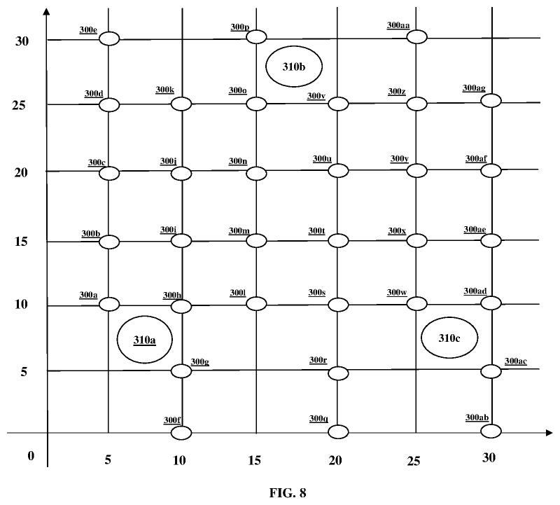

FIG. 8 illustrates an example environment comprising the plurality of sensors and sensor management controllers of the sensor system in an graphical representation, according to an embodiment as disclosed herein.

Referring to FIG. 8 illustrates another example indoor environment with sensors (300a-300ag) and sensor management controllers (310a, 310b and 310c). The sensors (300a-300k) controlled by the sensor management controller (310a) and the sensors (300l-300v) controlled by the sensor management controller (310b). Further, the sensors (300w-300ag) controlled by the sensor management controller (310c). The sensors (300a-300k) transferring the location information of the nearby sensors to the sensor management controller (310a) and the sensors (300l-300v) transferring the location information of the nearby sensors to the sensor management controller (310b). Further, the sensors (300w-300ag) transferring the location information of the nearby sensors to the sensor management controller (310c).

The sensor management controllers (310a-N) know their location information which is used in the sensor identification technique. Each sensor management controllers (310a-N) sending a unique command to the sensors (300a-N) which starts to communicate with another sensors (300b-N) and each sensors record the signal strength of its nearby sensors. The sensor management controllers (310a-N) stores the location information received from the sensors (300a-N) and transferring the location information to the cloud management server (400). The cloud management server (400) has the details of nearby sensors of each sensors (300a-N) under all the sensor management controllers (310a-N). The distance between the sensor (300a) and its nearby sensors (300b-N) are determined based on the signal strength between the sensor (300a) and its nearby sensors (300b-N).

$$Distance = {( \frac{{10}^{\frac{{Tx}_{p} - 30}{10}}}{{10}^{\frac{Rssi - 30}{10}}} * \frac{{Tx}_{gn} * {Rx}_{gn}}{{( 4 * PI )}^{2} * {( \frac{3 * {10}^{8}}{Frq} )}^{2}} )}^{( \frac{1}{n} )} \qquad ( 1 )$$

Where Txp is the Transmitter power,
Rssi is the Received power,
Txgn is the Transmitter gain,
Rxgn is the Receiver gain,
PI is the 3.14,
Frq is the Wireless frequency 2.4 GHz,
n is the environmental constant (2-4), for office space it
is 4, (Derived from Friis Equation).

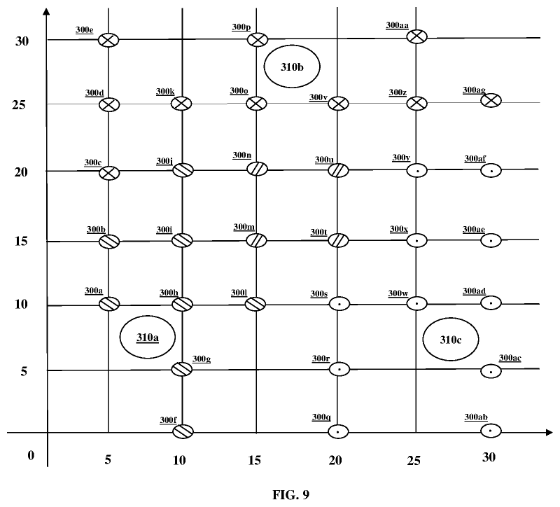

FIG. 9 illustrates another example environment comprising the plurality of sensors (300a-N) and sensor management controllers (310a-N) of the sensor system (200) in a graphical representation, according to an embodiment as disclosed herein.

Referring to the FIG. 9, a set of sensors of the plurality of sensors (300a-N) may be differentiated based on the proximity of the set of sensors to the sensor management controller of the plurality of sensor management controllers (310a-N).

Referring to the FIG. 9, a first set of sensors (300a, 300b, 300g, 300h, 300i, 300j, and 300l) are in proximity to a first sensor management controller (310a), a second set of sensors (300c, 300d, 300e, 300k, 300o, 300v, 300p, 300z, 300ag, and 300aa) are in proximity to a second sensor management controller (310b). Further, a third set of sensors (300q, 300r, 300s, 300w, 300ab, 300ac, 300ad, 300ae, and 300af) are in proximity to a third sensor management controller (310c). Among the plurality of sensors (300a-N), specific sensors such as for example (300m, 300n, 300u, and 300t) are commonly placed between the plurality of sensor management controllers (310a-c).

The cloud management server (400) is configured to collect the location information of the sensors (300a-N) from the sensor management controllers (310a-c). The cloud management server (400) segregates the sensors (300a-N) which are common to the one or more sensor management controllers (310a-c). For example, the sensors (300m, 300n, 300u, and 300t) are placed nearby the sensor management controllers (310a, 310b, and 310c). The cloud management server (400) already have the location information of the sensor management controllers (310a, 310b, and 310c) and also the cloud management server (400) is aware about the distance between each of the sensor management controllers (310a, 310b, and 310c) and the specific sensors (300m, 300n, 300u, and 300t). If the cloud management server (400) needs to identify the location of the sensor (300m), then the cloud management server (400) performs the below technique:

$${( x - x 1 )}^{2} + {( y - y 1 )}^{2} = r {1}^{2} - circle equation 1 from 310 a to 300 n \qquad ( 2 )$$

$${( x - x 2 )}^{2} + {( y - y 2 )}^{2} = r {2}^{2} - circle equation 2 from 310 b to 300 n \qquad ( 3 )$$

$${( x - x 3 )}^{2} + {( y - y 3 )}^{2} = r {3}^{2} - circle equation 3 from 310 c to 300 n \qquad ( 4 )$$

Where (x1, y1), (x2, y2) and (x3, y3) are the locations of 310a, 310b, 310c and r1, r2 and r3 are the distances from 300n to 310a, 310b, 310c respectively.

By solving the equations (2-4), the below equations are obtained:

$$2 ( x 2 - x 1 ) x + 2 ( y 2 - y 1 ) y = r 12 - r 22 - y 12 + y 22 - x 12 + x 22 \qquad ( 5 )$$

$$2 ( x 3 - x 2 ) x + 2 ( y 3 - y 2 ) y = r 22 - r 32 - y 22 + y 32 - x 22 + x 32 \qquad ( 6 )$$

$$2 ( x 1 - x 3 ) x + 2 ( y 1 - y 3 ) y = r 32 - r 12 - y 32 + y 12 - x 32 + x 12 \qquad ( 7 )$$

By taking any 2 equations from among equation (5 & 6)

$$2 ( x 2 - x 1 ) x + 2 ( y 2 - y 1 ) y = r {1}^{2} - r {2}^{2} - y {1}^{2} + y {2}^{2} - x {1}^{2} + x {2}^{2} \qquad ( 8 )$$

$$2 ( x 3 - x 2 ) x + 2 ( y 3 - y 2 ) y = r {2}^{2} - r {3}^{2} - y {2}^{2} + y {3}^{2} - x {2}^{2} + x {3}^{2} \qquad ( 9 )$$

To solve the equations (8 & 9), apply the Cramer's Rule

$$x = \frac{\begin{matrix}( ( r 1 \hat{} 2 - r 2 \hat{} 2 - y 1 \hat{} 2 + y 2 \hat{} 2 - x 1 \hat{} 2 + x 2 \hat{} 2 ) * 2 ( y 3 - y 2 ) - \\ ( r 2 \hat{} 2 - r 3 \hat{} 2 - y 2 \hat{} 2 + y 3 \hat{} 2 - x 2 \hat{} 2 + x 3 \hat{} 2 ) * 2 ( y 2 - y 1 ) )\end{matrix}}{( 2 ( x 2 - x 1 ) * 2 ( y 3 - y 2 ) - 2 ( y 2 - y 1 ) * 2 ( x 3 - x 2 ) )} \qquad Equation ( 10 )$$

$$y = \frac{\begin{matrix}( r 2 \hat{} 2 - r 3 \hat{} 2 - y 2 \hat{} 2 + y 3 \hat{} 2 - x 2 \hat{} 2 + x 3 \hat{} 2 ) * 2 ( x 2 - x 1 ) ) - \\ ( ( r 1 \hat{} 2 - r 2 \hat{} 2 - y 1 \hat{} 2 + y 2 \hat{} 2 - x 1 \hat{} 2 + x 2 \hat{} 2 ) * 2 ( x 3 - x 2 )\end{matrix}}{( 2 ( x 2 - x 1 ) * 2 ( y 3 - y 2 ) - 2 ( y 2 - y 1 ) * 2 ( x 3 - x 2 ) )} \qquad Equation ( 11 )$$

The cloud management server (400) identifies the position of the sensor (300n), by following the same technique the cloud management server (400) determines the locations of all remaining sensors (300m, 300u, and 300t). Further the location information associated with the sensors (300n, 300m, 300u, and 300t) is updated in the sensor location database (408), and the location information associated with the sensors (300n, 300m, 300u, and 300t) can be rearranged within the sensor location database (408). Also, simultaneously the location information of the remaining sensors (300a-N) are determined by the sensor location database (408).

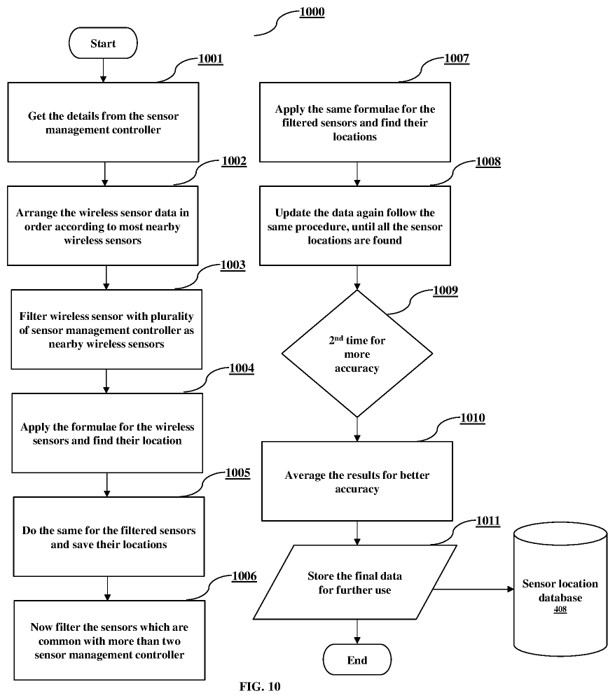

FIG. 10 is a flow chart illustrating step-by-step process for estimating a location of the plurality of sensors (300a-N) in the environment by the sensor system (200), according to an embodiment as disclosed herein.

Referring to FIG. 10 at step 1001, the method includes the cloud management server (400) receiving the location information of the sensors (300a-N) from the sensor management controllers (310a-N).

At step 1002, the method includes the cloud management server (400) arranging the list of the sensors (300a-N) in an order based on a proximity of the sensors (300a-N) with respect to the sensor management controllers (310a-N).

At step 1003, the method includes the cloud management server (400) filtering the list of the sensors (300a-N) which are in close proximity to the respective sensor management controllers (310a-N).

At step 1004, the method includes the cloud management server (400) applying the sensor identification technique along with the location information to each sensors (300a-N) to identify the location of each of the sensors (300a-N).

At step 1005, the method includes the cloud management server (400) applying the sensor identification technique along with the location information to each of the filtered sensors (300a-N) to identify the location of each filtered wireless sensors (300a-N) with respect to the sensor management controllers (310a-N) and save the location of the filtered sensors (300a-N) in the sensor location database (408).

At step 1006, the method includes the cloud management server (400) filtering the sensors (300a-N) which are in common proximity to more than two sensor management controllers (310a-N).

At step 1007, the method includes the cloud management server (400) applying the sensor identification technique and find the location of the filtered sensors (300a-N) which are common to the more than two sensor management controllers (310a-N).

At step 1008, the method includes the cloud management server (400) updating the location information of the each wireless sensors (300a-N) until finding the location of the sensors (300a-N).

At step 1009, the method includes the cloud management server (400) repeating the previous steps (1003 to 1008) to improve the accuracy of the location of the sensors (300a-N).

At step 1010, the method includes the cloud management server (400) determining the average of the results obtained in the above steps, for better accuracy. For example, the position of the sensor (300a) is calculated based on the results obtained by receiving the plurality of nearby sensor parameters from the one or more sensor management controllers (310a-N).

At step 1011, the method includes the cloud management server (400) storing the final location information of the sensors (300a-N) in the database (408).

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the proposed method.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A sensor system (200) for managing sensors (300a-N) in an environment, wherein the sensor system (200) comprises:
at least one sensor (300a) of a plurality of sensors (300a-N) communicating with at least one another sensor (300b) in a vicinity and configured to determine at least one sensor (300a) parameter associated with the at least one another sensor (300b), wherein at least one sensor (300a) comprises:
a Neighboring sensor parameter database (307a) configured to store the at least one sensor (300a) parameter associated with the at least one another sensor (300b), wherein the at least one sensor (300a) parameter associated with the at least one another sensor (300b) is stored in an order based on a proximity of the at least one another sensor (300b);
at least one sensor management controller (310a) connected to the at least one sensor (300a) and the at least one another sensor (300b), and configured to determine at least one aggregated sensor parameter based on the at least one sensor (300a) parameter received from the plurality of sensors (300a-N); and
a cloud management server (400) connected to the at least one sensor management controller (310a) and configured to:
receive the at least one aggregated sensor parameter from the at least one sensor management controller (310a) and at least one environmental parameter, and
estimate a position of the at least one sensor (300a) and the at least one another sensor (300b) in the environment based on the at least one aggregated sensor parameter and the at least one environmental parameter.

2. The sensor system (200) as claimed in claim 1, wherein the at least one sensor management controller (310a) is configured to determine the at least one aggregated sensor parameter based on the received at least one sensor (300a) parameter comprises:
receive the at least one sensor (300a) parameter from the at least one sensor (300a) and at least one another sensor (300b) parameter from the at least one another sensor (300b);
perform at least one aggregation technique pre-configured at the at least one sensor management controller (310a) on the received the at least one sensor (300a) parameter and the at least one another sensor (300b) parameter; and
determine the at least one aggregated sensor parameter based on the at least one aggregation technique performed on the received at least one sensor (300a) parameter and the at least one another sensor (300b) parameter.

3. The sensor system (200) as claimed in claim 2, wherein the at least one sensor management controller (310a) is further configured to:
send the at least one aggregated sensor parameter to the cloud management server (400) through a pre-established communication link.

4. The sensor system (200) as claimed in claim 1, wherein the at least one sensor (300a) is configured to determine the at least one sensor (300a) parameter associated with the at least one another sensor (300b) comprises:
determine a signal strength associated with the at least one another sensor (300b) in the vicinity of the at least one sensor (300a);
determine a position of the at least one another sensor (300b) corresponding to the at least one sensor (300a); and
determine the at least one sensor (300a) parameter associated with the at least one another sensor (300b) based on the signal strength associated with the at least one another sensor (300b) and the position of the at least one another sensor (300b) corresponding to the at least one sensor (300a).

5. The sensor system (200) as claimed in claim 1, wherein estimate the position of the at least one sensor (300a) and the at least one another sensor (300b) in the environment based on the at least one aggregated sensor parameter and the at least one environmental parameter comprises:
determine an identity of the at least one sensor management controller (310a) sending the at least one aggregated sensor parameter;
determine a position of the at least one sensor management controller (310a) in the environment based on the at least one environmental parameter;
filter the at least one sensor (300a) and the at least one another sensor (300b) based on the identity of the at least one sensor management controller (310a);
perform a sensor identification technique on the filtered at least one sensor (300a) and the at least one another sensor (300b); and
estimate the position of the at least one sensor (300a) and the at least one another sensor (300b) in the environment.

6. The sensor system (200) as claimed in claim 5, wherein the sensor identification technique comprises mapping of the filtered at least one sensor (300a) and the at least one another sensor (300b) based on the at least one environmental parameter.

7. The sensor system (200) as claimed in claim 1, wherein the at least one environmental parameter is a layout of the environment, a layout density of the plurality of sensors in the environment, a height information associated with the environment, unique ID associated with each of the at least one sensor (300a) and the at least one another sensor (300b), and positon information of the at least one sensor management controller (310a).

8. The sensor system (200) as claimed in claim 1, wherein the cloud management server (400) is further configured to:
determine at least one control command to be executed on the at least one sensor (300a) and the at least one another sensor (300b) based on the estimated position; and
send the at least one control command to the at least one sensor (300a) and the at least one another sensor (300b) through the at least one sensor management controller (310a).

9. The sensor system (200) as claimed in claim 1, wherein the cloud management server (400) is further configured to:
send the estimated position of the at least one sensor (300a) and the at least one another sensor (300b) and the at least one environmental parameter associated with the environment, through the at least one sensor management controller (310a) to a display device, wherein the display device displays the estimated position with respect to the at least one environmental parameter.

10. A method for managing sensors in an environment, wherein the method comprises:
determining, by at least one sensor (300a) of a plurality of sensors (300a-N) of a sensor system (200), at least one sensor parameter associated with the at least one another sensor (300b) based on communicating with at least one another sensor (300b) in a vicinity;
storing, by the at least one sensor (300a) of the plurality of sensors (300a-N) of the sensor system (200), the at least one sensor parameter associated with the at least one another sensor (300b) in an order based on a proximity of the at least one another sensor (300b);
transferring, by the at least one sensor (300a) of the plurality of sensors (300a-N) of a sensor system (200), the at least one sensor parameter to at least one sensor management controller (310a);
determining, by the at least one sensor management controller (310a), an at least one aggregated sensor parameter based on the at least one sensor parameter received from the plurality of sensors (300a-N), wherein the at least one sensor management controller (310a) connected to the at least one sensor (300a);
transferring, by the at least one sensor management controller (310a), the at least one aggregated sensor parameter to a cloud management server (400) connected to the at least one sensor management controller (310a); and
estimating, by the cloud management server (400), a position of the at least one sensor (300a) and the at least one another sensor (300b) in the environment based on the at least one aggregated sensor parameter and the at least one environmental parameter.

11. The method as claimed in claim 10, wherein determining, by the at least one sensor management controller (310a), the at least one aggregated sensor parameter based on the received at least one sensor parameter comprises:
receiving, by the at least one sensor management controller (310a), the at least one sensor parameter from the at least one sensor (300a) and at least one another sensor (300b) parameter from the at least one another sensor (300b);
performing, by the at least one sensor management controller (310a), at least one aggregation technique on the received the at least one sensor parameter and the at least one another sensor (300b) parameter; and
determining, by the at least one sensor management controller (310a), the at least one aggregated sensor parameter based on the at least one aggregation technique performed on the received at least one sensor parameter and the at least one another sensor (300b) parameter.

12. The method as claimed in claim 11, wherein sending, by the at least one sensor management controller (310a), the at least one aggregated sensor parameter to the cloud management server (400) through a pre-established communication link.

13. The method as claimed in claim 10, wherein determining, by the at least one sensor (300a), the at least one sensor parameter associated with the at least one another sensor (300b) comprises:
determining, by the at least one sensor (300a), a signal strength associated with the at least one another sensor (300b) in the vicinity of the at least one sensor (300a) and determining position of the at least one another sensor (300b) corresponding to the at least one sensor (300a); and
determining. by the at least one sensor (300a), the at least one sensor parameter associated with the at least one another sensor (300b) based on the signal strength associated with the at least one another sensor (300b) and the position of the at least one another sensor (300b) corresponding to the at least one sensor (300a).

14. The method as claimed in claim 10, wherein estimating, by the cloud management server (400), the position of the at least one sensor (300a) and the at least one another sensor (300b) in the environment based on the at least one aggregated sensor parameter and the at least one environmental parameter comprises:
determining, by the cloud management server (400), an identity of the at least one sensor management controller (310a) sending the at least one aggregated sensor parameter;
determining, by the cloud management server (400), a position of the at least one sensor management controller (310a) in the environment based on the at least one environmental parameter;
filtering, by the cloud management server (400), the at least one sensor (300a) and the at least one another sensor (300b) based on the identity of the at least one sensor management controller (310a);
performing, by the cloud management server (400), a sensor identification technique on the filtered at least one sensor (300a) and the at least one another sensor (300b); and
estimating, by the cloud management server (400), the position of the at least one sensor (300a) and the at least one another sensor (300b) in the environment.

15. The method as claimed in claim 14, wherein mapping, by the sensor identification technique, the filtered at least one sensor (300a) and the at least one another sensor (300b) based on the at least one environmental parameter.

16. The method as claimed in claim 10, wherein the at least one environmental parameter is a layout of the environment, a layout density of the plurality of sensors (300a-N) in the environment, a height information associated with the environment.

17. The method as claimed in claim 10, further comprising:
determining, by the cloud management server (400), at least one control command to be executed on the at least one sensor (300a) and the at least one another sensor (300b) based on the estimated position; and
sending, by the cloud management server (400), the at least one control command to the at least one sensor (300a) and the at least one another sensor (300b) through the at least one sensor management controller (310a).

18. The method as claimed in claim 10, further comprising:
sending, by the cloud management server (400), the estimated position of the at least one sensor and the at least one another sensor (300b) and the at least one environmental parameter associated with the environment, through the at least one sensor management controller (310a) to a display device, wherein displaying, by the display device, the estimated position with respect to the at least one environmental parameter.
